(19) United States
(12) Patent Application Publication
(10) Pub. No.: US 2006/0120944 A1
(43) Pub. Date: Jun. 8, 2006

(54) Compositions and methods for gas and liquid purification

(76) Inventor: Viktor I. Petrik, Moscow (RU)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/007,698

(22) Filed: Dec. 7, 2004

(51) Int. Cl. C01B 31/04; C09C 1/56

(52) U.S. Cl. 423/448; 423/460

(57) ABSTRACT

Nanostructured carbonaceous material is employed to bind and/or remove a contaminant from a medium, wherein the smallest dimension of the carbonaceous material is less than 500 nm, and wherein the material is present in an amount of at least 10 wt %. Particularly preferred carbonaceous material includes graphene.

### FIELD OF THE INVENTION

The field of the invention is gas and liquid purification, especially as it relates to flue gas purification.

### BACKGROUND OF THE INVENTION

Activated charcoal is used for numerous processes in which a contaminant is removed from a gaseous and/or liquid medium, and there are numerous types of activated charcoal known in the art. The particular choice of activated charcoal is at least partially determined by the type of contaminant and medium, as absorption of the contaminant is to a large extent dependent on the pore size in the activated charcoal.

For example, in a typical activation process, bulk charcoal is heated with steam and in the absence of oxygen to a temperature of about 1000° C. to remove residual non-carbon elements and to form a porous internal microstructure in which the pore size is generally between about 10-100 nanometers. Where desirable, smaller pore sizes (e.g., less than 10 nanometers) or larger pore sizes (e.g., larger than 100 nanometers) may be achieved by varying the activation conditions. Therefore, the sorption capacity of activated charcoal will be determined in most applications by the porosity, and is therefore often not specific towards a particular contaminant. Still further, while a typical activation process often provides at some control over pore size and distribution, exact control of these parameters is generally problematic.

To overcome at least some of the problems associated with the control over pore size, carbon-based nanotubes can be used as an alternative to activated charcoal. For example, in a recent report, carbon nanotubes were employed as filter agents to remove petroleum compounds from contaminated drinking water. While nanotubes typically provide a relatively high degree over pore size and pore distribution, preparation of carbon nanotubes is often cost prohibitive. Moreover, assembly of the carbon nanotubes to a functional filter is generally limited to a few methods of manufacture.

Therefore, while various carbon-based materials and methods for removal of one or more contaminants are known in the art, all or almost all of them suffer from several disadvantages. Thus, there is still a need to provide improved carbon-based materials and methods to remove contaminants from a medium.

### SUMMARY OF THE INVENTION

The present invention is directed to compositions and methods for removing and binding of a contaminant or mixture of contaminants from a medium, wherein the composition preferably includes a nanosized and/or non-porous carbonaceous material.

In one aspect of the inventive subject matter, the composition comprises at least 10 wt % of carbonaceous particles in which the smallest dimension is less than 500 nm, wherein at least 50% of the particles are a material other than a carbon nanotube, and wherein the contaminant is bound to the carbonaceous particles in an amount of at least 50 wt %, and more typically at least 100 wt % of the carbonaceous particles. Contemplated compositions may be freely admixed with an gaseous or liquid environment containing the contaminant, and it is further contemplated that the carbonaceous particles may be coupled to a solid phase to which the carbonaceous material is immobilized, and/or that the particles may be enclosed in a carrier that is permeable to the contaminant.

In further preferred aspects, the smallest dimension of the carbonaceous material is less than 100 nm, and most preferably comprises a graphene. Optionally, a portion of the particles may further include tubular (e.g., single- or multi-walled carbon nanotubes) or spheroid (e.g., nanoonions, nanodiamonds) particles. Typically, the contaminant is bound to the particles in an amount that is at least equal to weight of the carbonaceous particles, and more typically at least 10 times the weight of the carbonaceous particles, and most typically at least 25 times the weight of the carbonaceous particles. Particularly contemplated (airborne) contaminants include various metals (e.g., mercury, copper, molybdenum), halogens (e.g., chlorine, chloride), and/or optionally substituted hydrocarbons (e.g., saturated linear hydrocarbon, aromatic hydrocarbon, optionally substituted with an alkyl and/or a halogen).

In another aspect, the composition for removing a compound or mixture of compounds from a medium includes at least 10 wt % graphene, more typically at least 30 wt % graphene, and most typically at least 90 wt % graphene, and may further include carbon nanotubes and/or other carbon-based structures. In most cases, a contaminant is bound to the graphene in an amount of at least 10 wt %, more typically at least 50 wt %, and most typically at least 100 wt %.

In yet another preferred aspect, so obtained compositions to which a contaminant is bound can be regenerated using various physical treatments, and especially contemplated treatments include heating (e.g., up to 2500° C.), compression (e.g., up to 1000 kg/cm²), and centrifugation (e.g., up to 10000×g).

Various objects, features, aspects and advantages of the present invention will become more apparent from the following detailed description of preferred embodiments of the invention.

### BRIEF DESCRIPTION OF THE DRAWINGS

FIG. 1 is an electron micrograph of a nanostructured carbonaceous material depicting a detail view of a graphene layer in a wrinkled configuration.

FIG. 2 is an electron micrograph of a nanostructured carbonaceous material depicting a detail view of multiple graphene layers in a wrinkled configuration.

FIG. 3 is an electron micrograph of a nanostructured carbonaceous material depicting a further magnified detail view of a graphene layer of FIG. 2.

FIG. 4 is an schematic exemplary drawing in which nanosized and/or non-porous carbonaceous material is used for adsorption of a contaminant.

### DETAILED DESCRIPTION

The inventors surprisingly discovered that a non-porous surface of various nanostructured carbonaceous materials can be effectively employed as a sorbent for numerous contaminants, and especially for contaminants disposed in a liquid and/or gaseous medium. Among other materials, especially preferred nanostructured carbonaceous materials include graphene, which may further be accompanied by carbon nanotubes and/or carbon nanoonions.

The term “carbonaceous material” as used herein refers to any material that includes at least 50 mol % carbon. Therefore, carbonized organic materials, amorphous carbon, graphite, and graphene are considered carbonaceous materials under the scope of this definition. As also used herein, the term “graphene” refers to a molecule in which a plurality of carbon atoms (e.g., in the form of five-membered rings, six-membered rings, and/or seven-membered rings) are covalently bound to each other to form a (typically sheet-like) polycyclic aromatic molecule. Consequently, and at least from one perspective, a graphene may be viewed as a single layer of carbon atoms that are covalently bound to each other (most typically Sp² bonded). It should be noted that such sheets may have various configurations, and that the particular configuration will depend (among other things) on the amount and position of five-membered and/or seven-membered rings in the sheet. For example, an otherwise planar graphene sheet consisting of six-membered rings will warp into a cone shape if a five-membered ring is present the plane, or will warp into a saddle shape if a seven-membered ring is present in the sheet. Furthermore, and especially where the sheet-like graphene is relatively large, it should be recognized that the graphene may have the electron-microscopic appearance of a wrinkled sheet. It should be further noted that under the scope of this definition, the term “graphene” also includes molecules in which several (e.g., two, three, four, five to ten, one to twenty, one to fifty, or one to hundred) single layers of carbon atoms (supra) are stacked on top of each other to a maximum thickness of less than 100 nanometers. Consequently, the term “graphene” as used herein refers to a single layer of aromatic polycyclic carbon as well as to a plurality of such layers having a thickness of less than 100 nanometers. Typically, the dangling bonds on the edge of the graphene are saturated with a hydrogen atom.

As further used herein, the term “carbon nanotube” refers to a cylindrical single- or multi-walled structure in which the wall(s) is (are) predominantly composed of carbon, wherein the diameter may be uniform or decreasing over the length of the nanotube. In some instances, the carbon nanotube can be curved, and is therefore also termed “carbon nanohorn”.

As also used herein, the term “contaminant” refers to any compound and/or mixture of compounds that is considered undesirable and/or detrimental to the medium in which the compound and/or mixture of compounds is disposed. Thus, contaminants that are particularly contemplated under this definition include various metals, salts, acids, and/or hydrocarbons, each of which may be present in a gaseous medium (e.g., ambient air, process air) or a liquid medium (e.g., water).

As yet further used herein, the term “non-porous” in conjunction with a material refers to a porosity (i.e., void space within the material itself) of the material of less than 5 vol %, and even more typically of less than 2 vol %. For example, a material having a total volume of 10 cubic micrometer is considered non-porous is that material has a total pore volume of less than 0.5 cubic micrometer. It should be noted that the annular space defined by a carbocyclic ring is not considered a pore under the definition provided herein. Also, where a material has a contorted shape (e.g., a graphene in a wrinkled, sheet-like configuration) within a given volume, the void space between the material in that volume is not considered a pore under the definition provided herein.

In one preferred aspect of the inventive subject matter, the inventors discovered that non-porous surfaces of nanostructured materials effectively bind (typically in a non-covalent manner) numerous contaminants, and especially various hydrocarbons, metals, acids, and bases from a variety of liquid and/or gaseous media. Among various other nanostructured materials, selected carbonaceous materials, and particularly graphene exhibited superior binding characteristics for various hydrocarbons, metals, acids, and bases. Viewed from another perspective, non-porous surfaces of carbonaceous materials with generally flat configuration (i.e., materials in which the first and second dimensions are substantially larger [e.g., at least 1000-fold] than the third dimension) are particularly effective, and have in most cases a smallest dimension of less than 500 nm, and more typically of less than 300 nm, even more typically of less than 200 nm, and most typically of less than 100 nm.

Thus, the inventors contemplate compositions having at least 10 wt % of a carbonaceous material in which the smallest dimension is less than 500 nm (in which preferably at least 50% of the material is a material other than a carbon nanotube), and in which a contaminant is bound to the carbonaceous material in an amount of at least the weight of the carbonaceous material. Further especially contemplated compositions comprise at least 10 wt % of graphene to which a contaminant is bound in an amount of at least 50% of the weight of the graphene.

With respect to the contemplated materials, it is generally preferred that the material is a carbonaceous material fabricated from commercially available starting materials, including coal, tar, coke, graphite, carbonized organic matter, and/or carbonized synthetic fibers. Furthermore, suitable materials also include synthetic compounds, and especially synthetic (preferably polycyclic) aromatic compounds. Contemplated materials may also be derivatized with one or more heteroatoms (e.g., optionally substituted nitrogen, oxygen, sulfur, etc.) and/or substituents. The term “substituted” as used herein also refers to a replacement of a chemical group or substituent (e.g., hydrogen) with a functional group, and particularly contemplated functional groups include nucleophilic (e.g., —NH₂, —OH, —SH, —NC, etc.) and electrophilic groups (e.g., C(O)OR, C(X)OH, etc.), polar groups (e.g., —OH), non-polar groups (e.g., aryl, alkyl, alkenyl, alkynyl, etc.), ionic groups (e.g., —NH₃⁺), halogens (e.g., —F, —Cl), and all chemically reasonable combinations thereof. Thus, the term “substituent” includes nucleophilic (e.g., —NH₂, —OH, —SH, —NC, etc.) and electrophilic groups (e.g., C(O)OR, C(X)OH, etc.), polar groups (e.g., —OH), non-polar groups (e.g., aryl, alkyl, alkenyl, alkynyl, etc.), ionic groups (e.g., —NH₃⁺), halogens (e.g., —F, —Cl), and all chemically reasonable combinations thereof.

In still further alternative aspects of the inventive subject matter, numerous other starting materials are also deemed appropriate so long as such materials include a significant fraction of carbon (at least 20 mol %) and can be reacted with an acid catalyst to obtain a nanostructured material. As used herein, the term “nanostructured material” refers to a material that has a smallest dimension of less than 500 nm, and more typically of less than 300 nm, even more typically of less than 200 nm, and most typically of less than 100 nm. It should be noted that micron-sized and larger graphite flakes have been previously prepared with a smallest dimension of at least several micrometers. However, such graphite flakes typically have an undesirable surface to volume ratio as well as a non-constrained surface (infra), and are therefore expressly excluded from the scope of the invention presented herein.

Remarkably, the inventors discovered that a reagent for carbon-carbon bond cleavage reactions can be employed to form from starting materials contemplated above a nanostructured carbonaceous material with a smallest dimension of less than 500 nm, more typically of less than 300 nm, even more typically of less than 200 nm, and most typically of less than 100 nm. In most preferred aspects, such reagents were used to produce graphene from the appropriate starting material (typically graphite). There are numerous carbon-carbon bond cleavage reagents known in the art, and all of them are considered suitable for use herein. However, particularly preferred reagents include commercially available activated acid catalysts (e.g., Catalog Item: Activated Acid Catalyst #3 (plasma-activated hydrochloric acid) by SupraCarbonic, LLC., 348 N. Eckhoff Street—Orange, Calif. 92868, USA; www.supracarbonic.com/products/). Formation of graphene using such reagents is particularly remarkable as “ . . . planar graphene itself has been presumed not to exist in the free state, being unstable with respect to the formation of curved structures such as soot, fullerenes, and nanotubes . . . ” [quoting Novoselov, K. S. et al. “Electric Field Effect in Atomically Thin Carbon Films”, Science, Vol 306, Issue 5696, 666-669, 22 Oct. 2004].

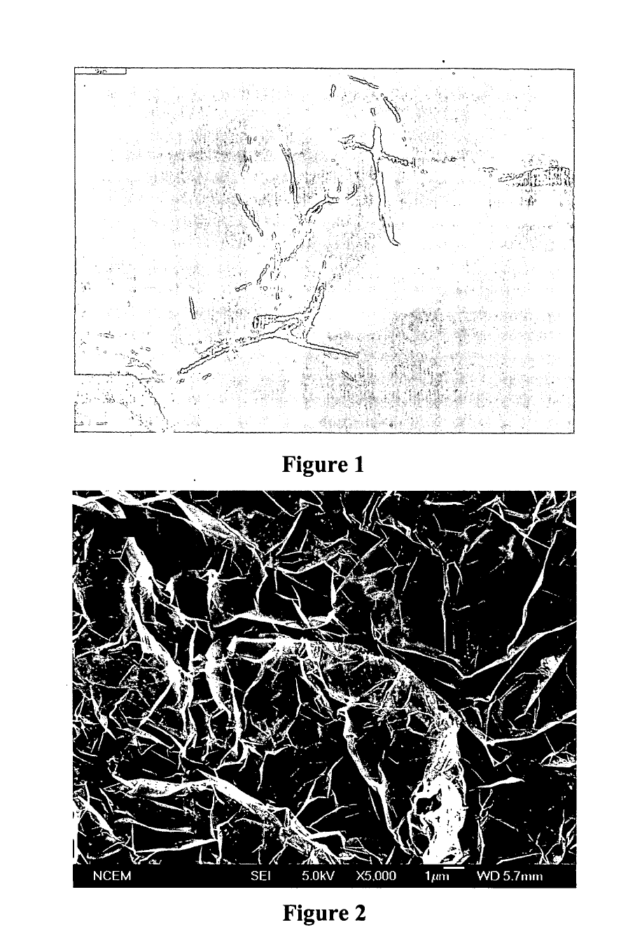

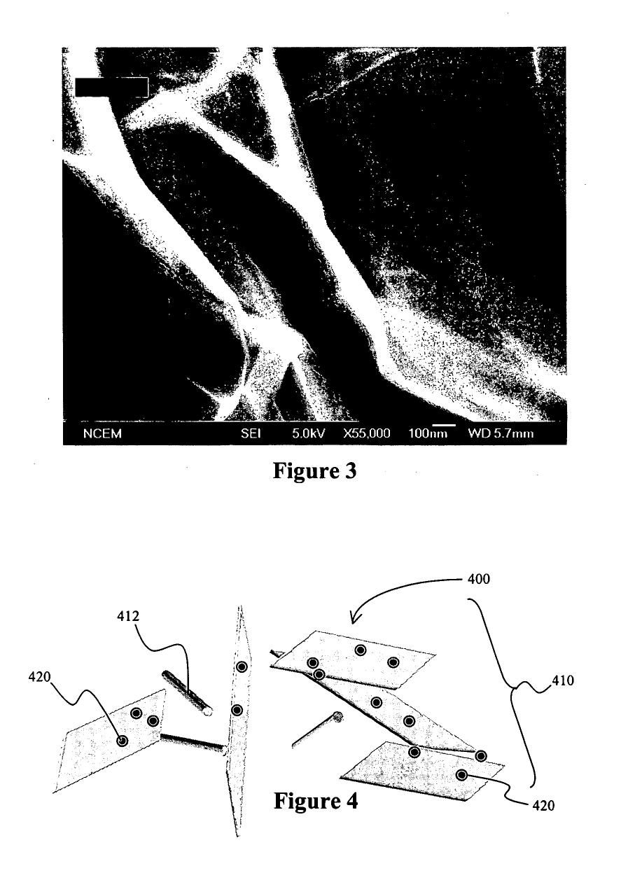

Electron micrographs of exemplary nanostructured materials (here: graphene) prepared according to the inventive subject matter are provided below. For example, FIG. 1 shows a detail view of a graphene structure at a magnification in which the bar in the top left corner of the image represents 2 micrometers. A further detail view is given in FIG. 2 in which the bar in the bottom line of the image represents 1 micrometer. Here, the graphene seen as ultra-thin and opaque layer is substantially contorted, while the areas where the sheet is folded and where the fold faces the observer is seen as white reflective lines/areas. A still higher magnification of the folded graphene structure is provided in FIG. 3 in which the bar in the bottom line of the image represents 100 nanometer. FIG. 4 depicts a schematic illustration in which composition 400 includes nanostructured material 410 (also including nanotubes 412) to which a contaminant 420 is bound. While not limiting to the inventive subject matter, the inventors contemplate that the contortions in the graphene result in a strain in the sp² geometry, which is thought to change electronic properties in a manner similar to the known orbital strain in carbon nanotubes. Such strained geometry is thought to contribute to the unusually high binding capacity of contemplated compositions to numerous contaminants.

Depending on the starting material and conditions of manufacture, suitable compositions may therefore include between 0.1 vol % and 99.9 vol % of nanostructured material, and it is especially preferred that the nanostructured material comprises graphene. Typically, the nanostructured material is present in an amount of at least 30%, more preferably at least 50%, even more preferably at least 70%, and most preferably at least 90%. However, based on further experimentation (data not shown), compositions according to the inventive subject matter can also include single- and multi-walled carbon nanotubes, carbon nanohoms, and/or carbon nanoonions. Where such other nanostructures are present, it is typically preferred that the single- and multi-walled carbon nanotubes, carbon nanohoms, and/or carbon nanoonions are present in an amount of less than 50%, more preferably less than 30% and most preferably less than 10%. Consequently, it is typically preferred that at least 50% of the nanostructured carbonaceous material is s a material other than a carbon nanotube.

Where desirable, it should be appreciated that contemplated compositions may be enclosed in a carrier that is permeable to at least a contaminant, and more typically also at least partially to the medium in which the contaminant is disposed. For example, where the medium is air and the contaminant is a hydrocarbon vapor, contemplated compositions may be disposed between a pair of inlet filters. In another example, where the medium is water and the contaminant is crude oil, contemplated compositions may be enclosed in a filter pad that is disposed in the water stream. Alternatively, where the medium is a flue gas and the contaminant is mercury, the composition may be injected into the flue gas stream and then collected via electrostatic precipitation and/or filters.

With respect to contaminants, it should be recognized that suitable contaminants can be readily identified by a person of ordinary skill in the art without undue experimentation. However, it is particularly preferred that contemplated contaminants include optionally substituted hydrocarbons (e.g., crude oil, refined hydrocarbons, chloroform, acteonitrile, benzene, toluene, xylene, etc.), metals (elemental [e.g., mercury], or in ionic form [e.g., Cu²⁺]), acids (e.g., HNO₃, H₃PO₄, H₂SO₄, lactic acid, etc.), bases (e.g., NaOH, KOH, HSO₄⁻, etc.), halogens (e.g., Cl₂, Cl⁻, etc.), salts of the above acids and bases, and numerous other chemical compounds, including small molecule drugs (MW typically less than 1000) and chemical agents (e.g., Sarin, Soman, Vx, Mustard Gas, and Lewisite). Depending on the specific nature of the contaminant, contemplated compositions will typically bind the contaminant in a non-covalent fashion in an amount that is at least 50-100% to the weight of the nanostructured material. However, and more typically, the contaminant will be bound in an amount of at least two times, more typically at least five times, even more typically at least twenty times, and most typically at least thirty times the weight of the nanostructured material. Exemplary binding characteristics for selected contaminants are provided in the section entitled “Examples” below.

Contaminants may be disposed in a gaseous medium and/or in a liquid medium, and it is generally contemplated that all manners of contacting the contaminant with contemplated compositions are suitable to remove at least a portion of the contaminant from the medium. For example, where the contaminant is disposed in a liquid medium, contemplated compositions may be admixed to the medium. Alternatively, the composition may also be contained in a container that allows passage of at least some of the contaminant through the container onto the nanostructured material. Similarly, the nanostructured material may be injected into a gas stream containing the contaminant then be removed (e.g., via precipitator or filter) once the contaminant has bound to the nanostructured material (preferably to a predetermined degree).

As the contaminant is non-covalently bound to the nanostructured carbonaceous material, it should be recognized that contemplated compositions can be regenerated in a relatively simple manner. Among other options, a large proportion (typically >70%) of the contaminant can be removed from the nanostructured carbonaceous material by centrifugal or compressive force, wherein the particular force will at least to some degree the release of the contaminant. For example, crude oil can be separated from a typical nanostructured carbonaceous material using centrifugal forces of >500×g. Alternatively, where possible, the contaminant can be thermally removed (e.g., sublimated or combusted) from the nanostructured carbonaceous material using temperatures of up to 3500° C. Further aspects, compositions, methods, and uses are disclosed in our commonly owned copending U.S. applications with the title “Binding And In Situ Destruction Of Chemical Agents And Other Contaminants” (filed Dec. 7, 2004) and “Mass Production Of Carbon Nanostructures” (filed Dec. 7, 2004), both of which are incorporated by reference herein.

### EXAMPLES

The following examples are provided only to illustrate selected aspects of the inventive subject matter and are not limiting to the inventive concept presented herein.

### Production of Nanostructured Carbonaceous Material

1 g of flake graphite (e.g., commercially available from Superior Graphite Company, 10 South Riverside Plaza, Chicago, Ill. 60606, or Crystal Graphite Corp., Vancouver, B.C., Canada) was admixed with 1 ml activated acid catalyst (e.g., Activated Acid Catalyst #3, commercially available from SupraCarbonic, 348 N. Eckhoff Street—Orange, Calif. 92868, USA) and briefly heated to expansion at 100° C. to about 200° C. The material was subsequently used without further purification.

### Sorption Capacity of Selected Contaminants

Table 1 provides an exemplary listing of sorption capacity of contemplated materials as compared to commercially available granulated activated charcoal. All values in the table reflect gram contaminant absorbed per gram of contemplated materials/granulated activated charcoal. In this series of experiments, the listed contaminants were contacted with the tested materials to saturation on a vacuum filter. At contaminant breakthrough, the materials were weighed. NCM is nanostructured carbonaceous material, GAC is activated charcoal, and ratio is expressed in fold amount sorption capacity of NCM over GAC.

TABLE 1

| Contaminant | NCM | GAC | Ratio |
|---|---|---|---|
| Crude Oil | 74.51 | 0.19 | 392 |
| Mineral Spirits | 29.21 | 0.188 | 155.37 |
| Naphtha | 24.14 | 0.202 | 119.5 |
| Turpentine | 26.68 | 0.178 | 149.88 |
| Kerosene | 40.16 | 0.224 | 179.28 |
| Diesel | 36.65 | 0.222 | 165 |
| Gasoline | 29.76 | 0.28 | 106.28 |
| Hexane | 27.54 | 0.262 | 105.11 |
| Toluene | 34.89 | 0.19 | 183.63 |
| Benzene | 31.63 | 0.272 | 116.28 |
| Isopropyl Alcohol | 22.79 | 0.212 | 107.5 |
| Acetonitrile | 32.1 | 0.244 | 131.56 |
| Tetrachloroethane | 38.22 | 0.282 | 135.53 |
| Chloroform | 24.55 | 0.264 | 92.99 |
| Dichloromethane | 32.76 | 0.204 | 160.58 |
| Nitric Acid | 51.33 | 0.208 | 246.77 |
| Phosphoric Acid | 60.28 | 0.232 | 259.82 |
| Sulfuric Acid | 36.54 | 0.218 | 167.61 |

### Contaminant Removal from Aqueous Medium

In this example, polluted water from a river was run through a filter packed with NCM and the water was tested before and after filtration for exemplary contaminants. All values are given as concentrations in mg/l and are listed in Table 2.

TABLE 2

| Contaminant | Before | After |
|---|---|---|
| Petroleum Derivatives | ˜3500 | 0.12 |
| Ether-soluble Fats | ˜3500 | 0.60 |
| Suspended Solids | 750 | 7 |
| Sulfides and H₂S | 0.10 | 0.017 |
| Copper | 0.75 | 0.02 |
| Orthophosphates | 44 | 1.2 |
| Cr⁶⁺ | 0.16 | 0.03 |
| Total Iron | 0.62 | 0.22 |
| Ammonia Nitrogen | 212 | 138 |
| Organic Nitrogen | 319 | 46 |
| Total Phosphorus | 58.2 | 2.3 |

### Contaminant Removal from Gaseous Medium

In this example, mercury vapor was introduced to flue gas and the spiked flue gas was run through a filter packed with NCM. Quantitative analysis revealed that 1 g of NCM bound about 240 g of mercury, while powdered activated charcoal bound approximately 40 g of mercury.

Thus, specific embodiments and applications of compositions and methods for gas and liquid purification have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A composition comprising at least 10 wt % carbonaceous material in which the smallest dimension is less than 500 nm, wherein at least 50% of the material is a material other than a carbon nanotube, and wherein a contaminant is bound to the carbonaceous material in an amount of at least a weight of the carbonaceous material.

2. The composition of claim 1 comprising at least 30 wt % the carbonaceous material, and wherein the contaminant is an airborne contaminant.

3. The composition of claim 1 further comprising a solid phase on which the carbonaceous material is immobilized.

4. The composition of claim 1 in which the smallest dimension of the carbonaceous material is less than 100 nm.

5. The composition of claim 1 wherein at least a portion of the carbonaceous material comprises a graphene.

6. The composition of claim 1 wherein the contaminant is bound to the material in an amount that is at least ten times the weight of the carbonaceous material.

7. The composition of claim 1 wherein a portion of the carbonaceous material has a tubular or spheroid configuration.

8. The composition of claim 1 wherein the contaminant comprises a metal or a halogen.

9. The composition of claim 8 wherein the metal is selected from the group consisting of mercury, copper, and molybdenum.

10. The composition of claim 1 wherein the contaminant comprises a hydrocarbon.

11. The composition of claim 10 wherein the hydrocarbon is selected from the group consisting of a saturated linear hydrocarbon, and an aromatic hydrocarbon, and wherein the hydrocarbon is optionally substituted with at least one of an alkyl and a halogen.

12. A method of removing a contaminant from a medium comprising a step of contacting the contaminant in the medium with a composition according to claim 1 for a time effective to allow binding of the contaminant to the composition in an amount of at least the weight of the carbonaceous material.

13. The method of claim 12 wherein the smallest dimension of the carbonaceous material is less than 100 nm.

14. The method of claim 12 wherein the contaminant is and airborne contaminant and bound to the material in an amount that is at least ten times the weight of the carbonaceous material.

15. The method of claim 12 wherein the contaminant is a metal, a halogen, or an optionally substituted hydrocarbon.

16. A composition comprising at least 10 wt % graphene to which a contaminant is bound in an amount of at least 50% of a weight of the graphene.

17. The composition of claim 16 comprising at least 70 wt % graphene.

18. The composition of claim 16 wherein the contaminant is selected from the group consisting of a metal, a halogen, and an optionally substituted hydrocarbon.

19. A method of removing a contaminant from a medium comprising a step of contacting the contaminant in the medium with a composition that includes at least 10 wt % graphene.

20. The method of claim 19 wherein the composition comprises at least 30 wt % graphene, and wherein the contaminant is a metal, a halogen, an optionally substituted hydrocarbon, or a chemical agent, and wherein the medium is air.

21. The method of claim 19 wherein the contaminant is a metal, a halogen, or an optionally substituted hydrocarbon.

22. The method of claim 19 wherein the composition further comprises a carbon nanotube.

23. The method of claim 19 wherein the graphene is immobilized on a solid phase.

24. A method of removing a contaminant from a composition according to any one of claim 1 or claim 16 comprising a step of subjecting the composition to a physical treatment selected from the group consisting of heating the composition, compressing the composition, and centrifuging the composition.
